(19) United States
(12) Patent Application Publication
(10) Pub. No.: US 2026/0339253 A1
(43) Pub. Date: Oct. 29, 2026

(54) PAPER ALIGNMENT APPARATUS

(71) Applicant: KYOCERA DOCUMENT SOLUTIONS INC., OSAKA (JP)

(72) Inventor: DAIJIRO UENO, OSAKA (JP)

(21) Appl. No.: 19/536,174

(22) Filed: Feb. 10, 2026

(30) Foreign Application Priority Data
Feb. 19, 2025 (JP) 2025-025136

(51) Int. Cl. G03G 15/00; G03G 15/23

(52) U.S. Cl. CPC G03G 15/6502; G03G 15/234; G03G 15/5062; B65H 2220/01; B65H 2404/1521

(57) ABSTRACT

A paper alignment apparatus is a paper alignment apparatus for adjusting a paper skew, including an alignment plate arranged parallel to a paper feed direction and a width guide mechanism for pushing paper against the alignment plate. The paper includes thin paper or thick paper. The width guide mechanism includes paper rollers in contact with the paper, a first width guide spring for applying a load to the thin paper or the thick paper, and a second width guide spring for applying a load to the thick paper. The first width guide spring applies a load to the paper when the paper rollers are pressed by the paper. The second width guide spring applies a load to the paper when an amount of movement of the paper rollers pressed by the paper is greater than or equal to a first threshold.

### CROSS-REFERENCE TO RELATED PATENT APPLICATION

This application claims the benefit of Japanese Priority Patent Application JP 2025-025136 filed Feb. 19, 2025, the entire contents of which are incorporated herein by reference.

### FIELD OF THE DISCLOSURE

The present disclosure relates to a paper alignment apparatus applicable for aligning paper during paper transport in an image forming apparatus.

### BACKGROUND OF THE DISCLOSURE

In the related art, paper transported by an image forming apparatus incorporates a structure to prevent buckling.

For example, a generally known image forming apparatus transports a recording material while gripping it and includes a skew correction means to correct a skew of the recording material during the transport. In this image forming apparatus, when the recording material is supplied without passing through a reversing transport means that reverses front and back sides of the image-formed recording material and transports the reversed recording material toward the skew correction means, a pressure for gripping the recording material in the skew correction means is set to a first pressure, and when the recording material is supplied to the skew correction means via the reverse transport means, a pressure is set to a second pressure lower than the first pressure.

### SUMMARY OF THE DISCLOSURE

To achieve the above object, a paper alignment apparatus according to an embodiment of the present disclosure is a paper alignment apparatus for adjusting a paper skew, including an alignment plate arranged parallel to a paper feed direction and a width guide mechanism for pushing paper against the alignment plate.

The paper includes thin paper or thick paper.

The width guide mechanism includes paper rollers in contact with the paper, a first width guide spring for applying a load to the thin paper or the thick paper, and a second width guide spring for applying a load to the thick paper.

The first width guide spring applies a load to the paper when the paper rollers are pressed by the paper.

The second width guide spring applies a load to the paper when an amount of movement of the paper rollers pressed by the paper is greater than or equal to a first threshold.

### BRIEF DESCRIPTION OF THE DRAWINGS

FIG. 1 is a front view schematically showing a configuration of an image forming apparatus.

FIG. 2 is a schematic view showing an example of a paper alignment apparatus.

FIG. 3 is a schematic view showing an example of a paper feed mechanism.

FIG. 4 is a view of the paper feed mechanism with a sheet metal removed.

FIG. 5 is a schematic view showing an example of a paper width guide mechanism.

FIG. 6 is a schematic view showing an example of a width guide moving body.

FIG. 7 is a view of the width guide moving body as seen from an arrow direction A.

FIG. 8 is a view showing a state where no paper exists in a paper transport area (standby state).

FIG. 9 shows a state where the paper is thin paper (or plain paper) and exists in the paper transport area.

FIG. 10 shows a state where the paper is thick paper and exists in the paper transport area.

FIG. 11 is a graph indicating a load applied in a paper width guide direction (opposite to the X direction).

### DETAILED DESCRIPTION OF THE EXEMPLARY EMBODIMENTS

Hereinafter, embodiments of the present disclosure will be described with reference to the drawings.

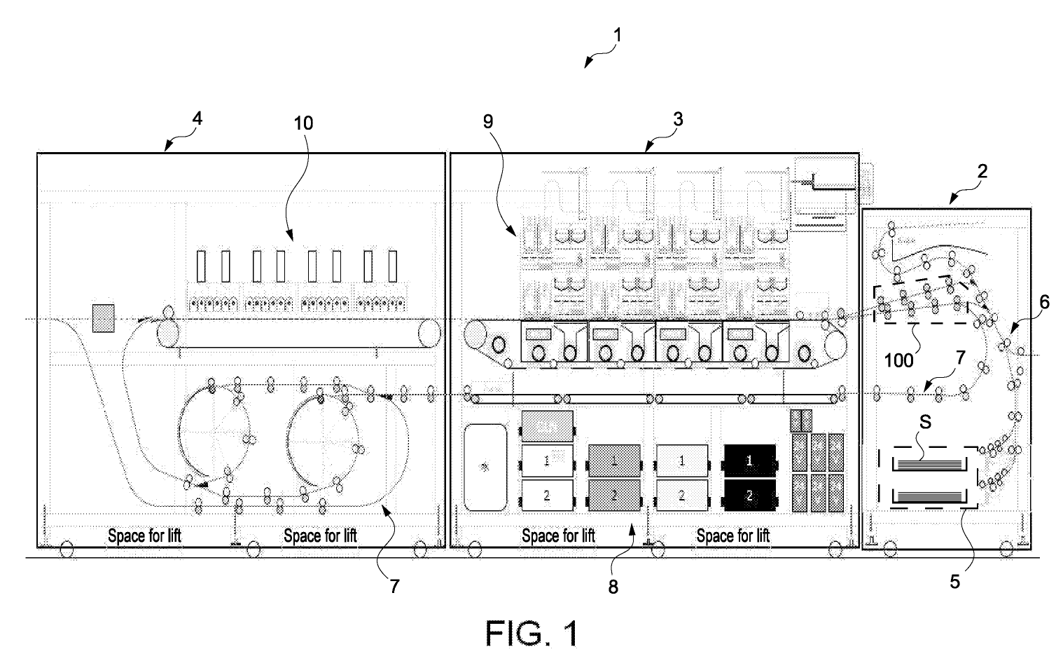

FIG. 1 is a front view schematically showing a configuration of an image forming apparatus 1.

As shown in FIG. 1, the image forming apparatus 1 includes a paper feed unit 2, an image forming unit 3, and a drying unit 4.

The paper feed unit 2 stores and transports paper S on which an image is formed. The paper feed unit 2 also includes a storage unit 5 for storing single-sheet paper such as plain paper or coated paper, and paper transport units 6 including multiple rollers that feed the paper S from the storage unit 5, a paper alignment apparatus 100 for adjusting a skew and optical axis misalignment of the paper, and reversing transport units 7 for transporting the paper on which the image is formed on one side (e.g., a front side) to be reversed to form an image on the other side (e.g., a back side).

For simplicity, the paper transport units 6 and the reversing transport units 7 include all rollers and transport paths, etc., that transport the paper S arranged in the paper feed unit 2, the image forming unit 3, and the drying unit 4.

The image forming unit 3 forms the image by ejecting ink S onto the paper transported from the paper feed unit 2. For example, the image forming unit 3 includes ink containers 8 filled with yellow, black, cyan, and magenta inks, ejection units 9 that eject the ink of respective colors from the ink containers 8 onto the paper, and a drive circuit (not shown) that controls an amount of the ink ejected by the ejection units 9.

The drying unit 4 dries the ink ejected onto the paper S. For example, the drying unit 4 includes drying units 10 that dry the ink by emitting warm air, cold air, infrared rays, etc. Any arrangement or any number of the drying units 10 may be used.

For example, when printing on the front side of the paper S, the paper S stored in the storage unit 5 is fed into the transport path by rotation of the rollers of the paper transport units 6. The skew and the optical axis misalignment are adjusted by the paper alignment apparatus 100, and the paper is then transported to the image forming unit 3. Furthermore, on the basis of image data input to the image forming apparatus 2, the ink is ejected onto the paper S transported by the paper transport units 6, thereby forming the image on the paper. Subsequently, the ink ejected onto the front side of the paper S is dried by the drying unit 4.

For example, when printing the back side of the paper S, the paper S on which the image is formed on the front side is reversed by the reversing transport units 7, then passes through the image forming unit 3, and is transported to the paper feed unit 2. The paper S transported is adjusted for the skew and the optical axis misalignment by the paper alignment apparatus 100 and is transported again to the image forming unit 3. Furthermore, on the basis of the image data input to the image forming apparatus 1, the ink is ejected onto the paper S transported, forming the image on the paper. Subsequently, the ink ejected onto the back side of the paper is dried by the drying unit 3.

It should be appreciated that the image forming apparatus 1 may also include a control unit that reads and executes control programs using a CPU (Central Processing Unit), a memory unit including a storage medium such as a ROM (Read Only Memory), and an operation unit that accepts a user operation.

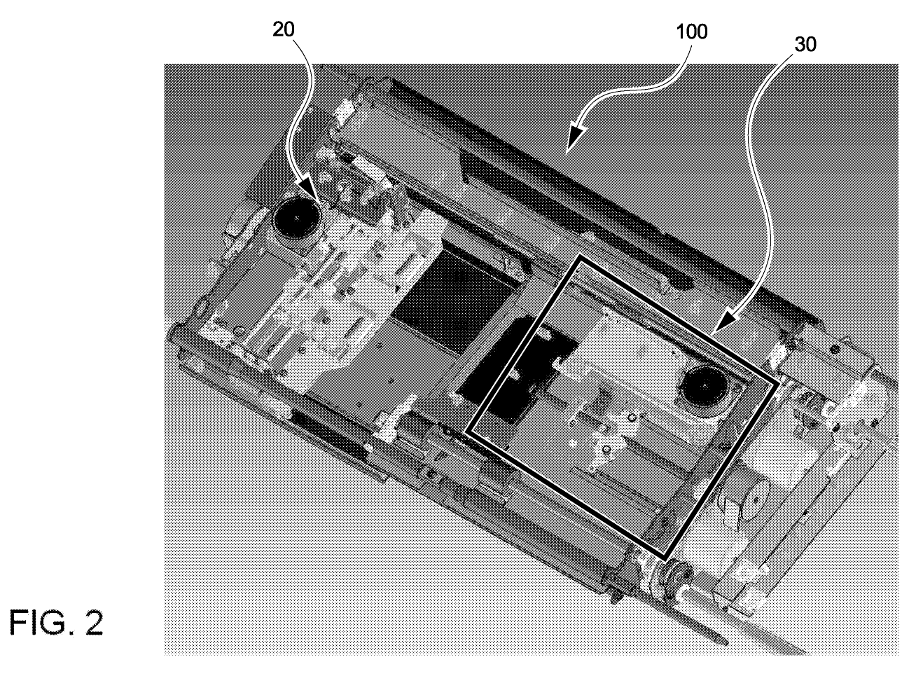

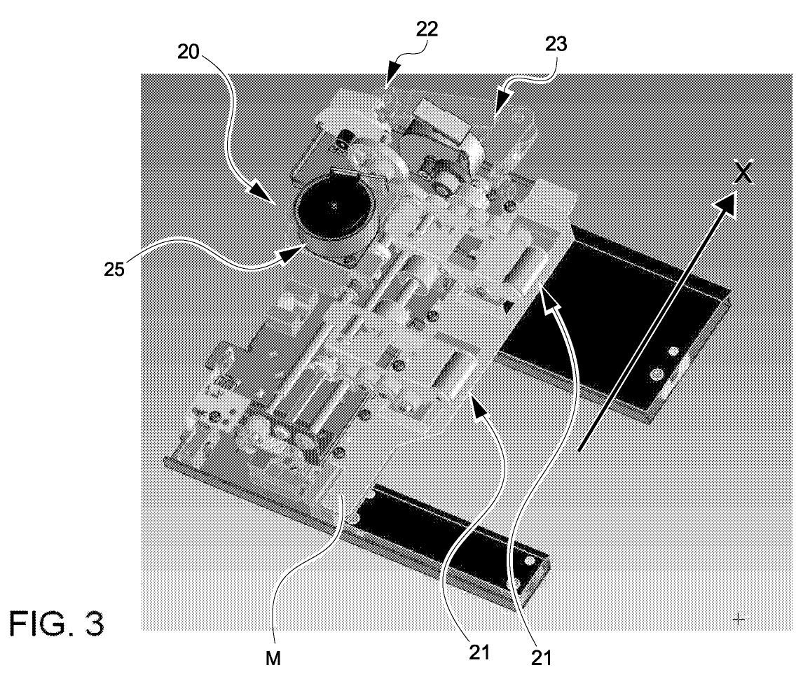

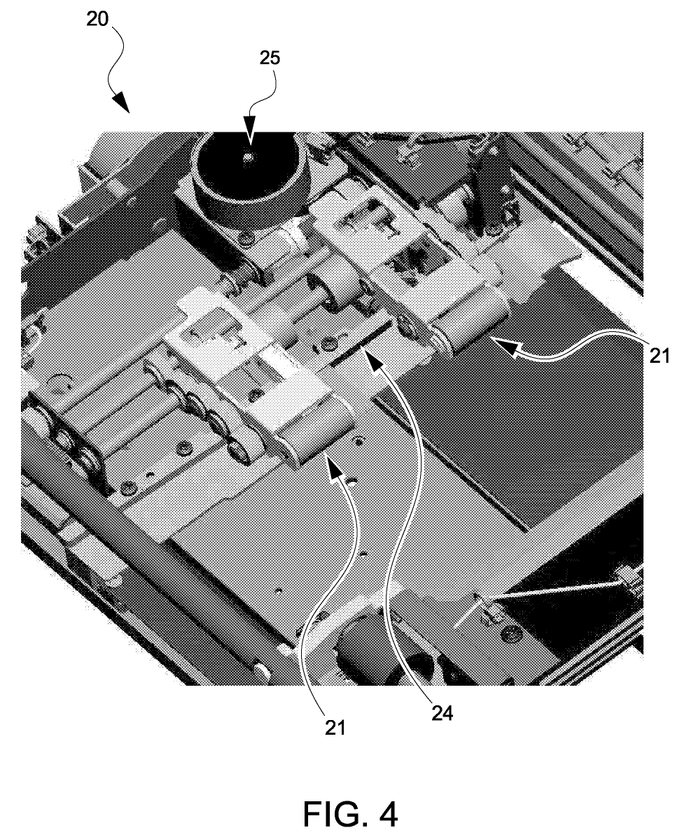

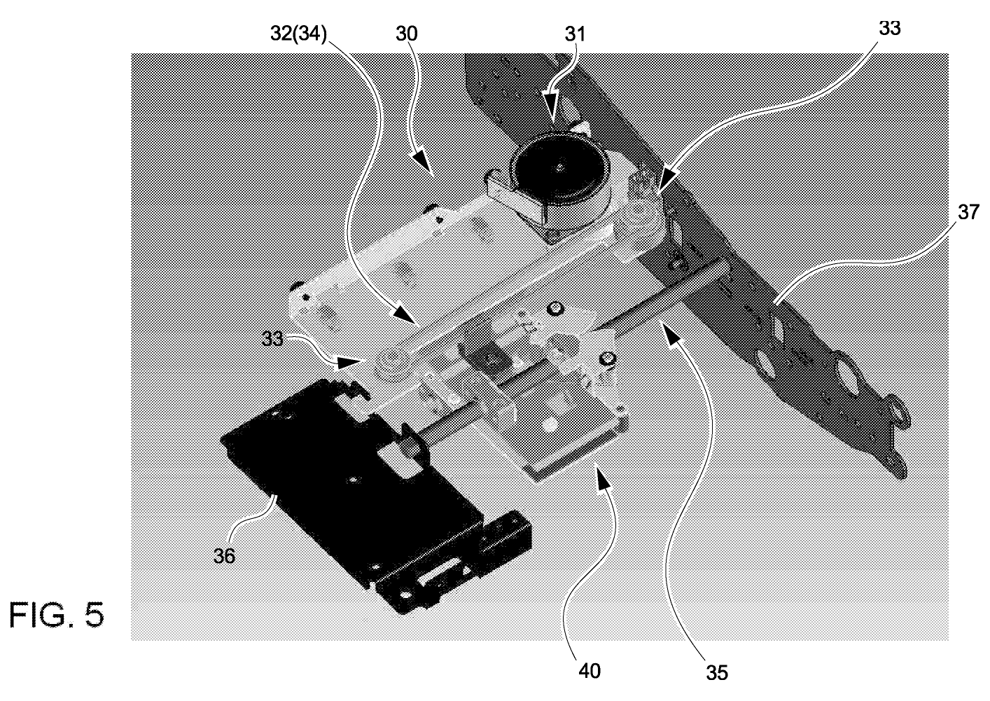

FIG. 2 is a schematic view showing an example of the paper alignment apparatus 100. FIG. 3 is a schematic view showing an example of a paper feed mechanism 20. FIG. 4 is a view of the paper feed mechanism 20 with the sheet metal M removed. FIG. 5 is a schematic view showing an example of a paper width guide mechanism 30.

As shown in FIG. 2, the paper alignment apparatus 100 includes the paper feed mechanism 20 and the paper width guide mechanism 30.

The paper feed mechanism 20 includes multiple rollers for aligning the paper and motors for driving these rollers. For example, in FIG. 3, the paper feed mechanism 20 includes two alignment rollers 21, an alignment roller drive motor 22 for driving the alignment rollers 21 in a rotational direction, an alignment roller lift motor 23 for raising and lowering the alignment rollers 21 to bring them into contact with or separate from the paper, and an alignment plate 24 (see FIG. 4) arranged parallel to a paper transport direction X.

For example, the paper feed mechanism 20 drives the alignment roller lifting motor 23 upon detection of the paper by a sensor (not shown), lowering the separated alignment rollers 21 to contact the paper. Furthermore, the paper feed mechanism 20 drives the alignment roller transport motor 22 to rotate the alignment rollers 21 while the alignment rollers 21 are in contact with the paper, thereby correcting a paper skew.

An alignment plate actuator motor 25 retracts the alignment plate 24 to prevent collision with the paper as the paper enters. The alignment plate actuator motor 25 moves the alignment plate 24 to a specified position when the paper stops at the paper alignment apparatus 100. That is, the alignment plate 24 repeatedly retracts and moves each time the paper enters. In this embodiment, a distance between the alignment plate 24 and each alignment roller 21 is set to prevent the paper from being crushed. If the distance is too large, the paper will be crushed, but if the distance is small, the paper slides under the alignment rollers 21 and is not crushed.

As shown in FIG. 5, the paper width guide mechanism 30 includes a width guide motor 31, a width guide belt 32, a support rod 35, and a width guide moving body 40.

The width guide motor 31 drives the width guide belt 32. The width guide belt 32 includes support members 33 supporting a belt 34 at both ends and the belt 34 that moves the width guide moving body 40. For example, a gear (not shown) connected to one of the support members 33 rotates due to the drive of the width guide motor 31, causing the belt 34 to move left and right.

The support rod 35 is fixed to a sub-assembly 36 crimping the support rod 35 and to a front frame 37, supporting the width guide moving body 40. The support rod 35 is also arranged along a direction in which the width guide belt 32 extends. Consequently, the width guide moving body 40 connected to the belt 34 moves along a direction in which the support rod 35 extends.

For example, the width guide motor 31 drives according to a width (size) and a type of the paper transported, adjusting a position of the width guide belt 32. A position of the width guide moving body 40 is determined by a movement of the belt 34 of the width guide belt 32.

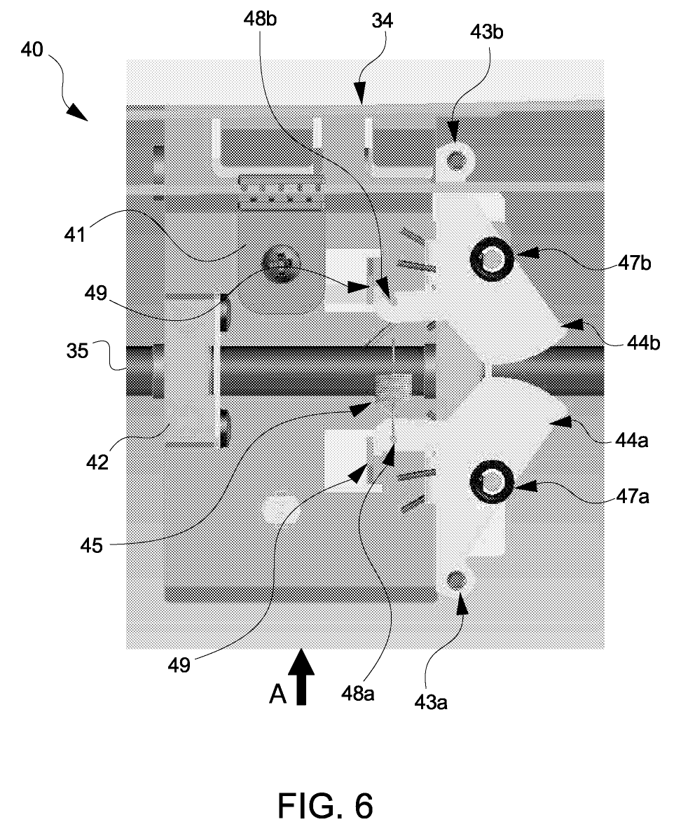

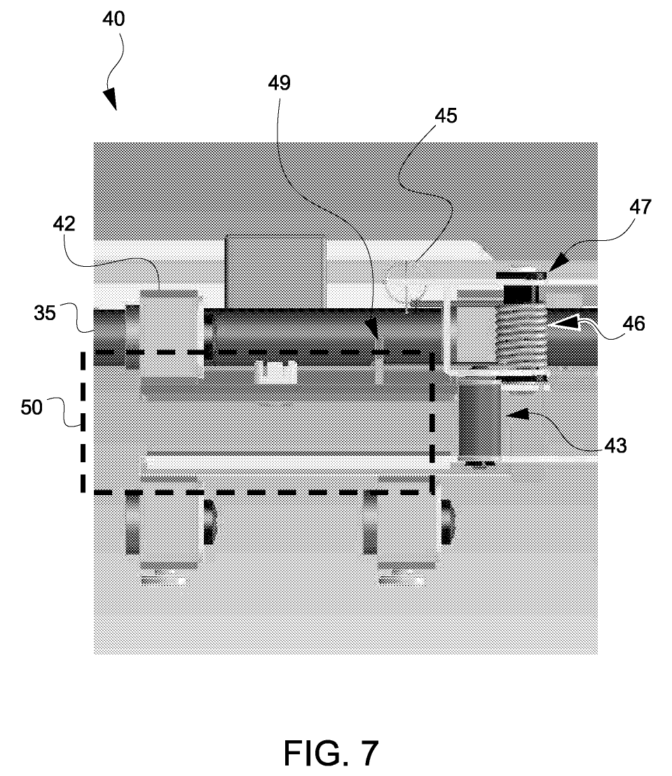

FIG. 6 is a schematic view showing an example of the width guide moving body 40. FIG. 7 is a view of the width guide moving body 40 as seen from an arrow direction A.

As shown in FIGS. 6 and 7, the paper width guide body 40 includes a connecting member 41 connected to the width guide belt 34, a support member 42 held by the support rod 35 and configured to slide in an extension direction of the support rod 35, paper width guide rollers 43, paper width guide levers 44, a first width guide spring 45, a second width guide spring 46 (see FIG. 7), and a stopper 49.

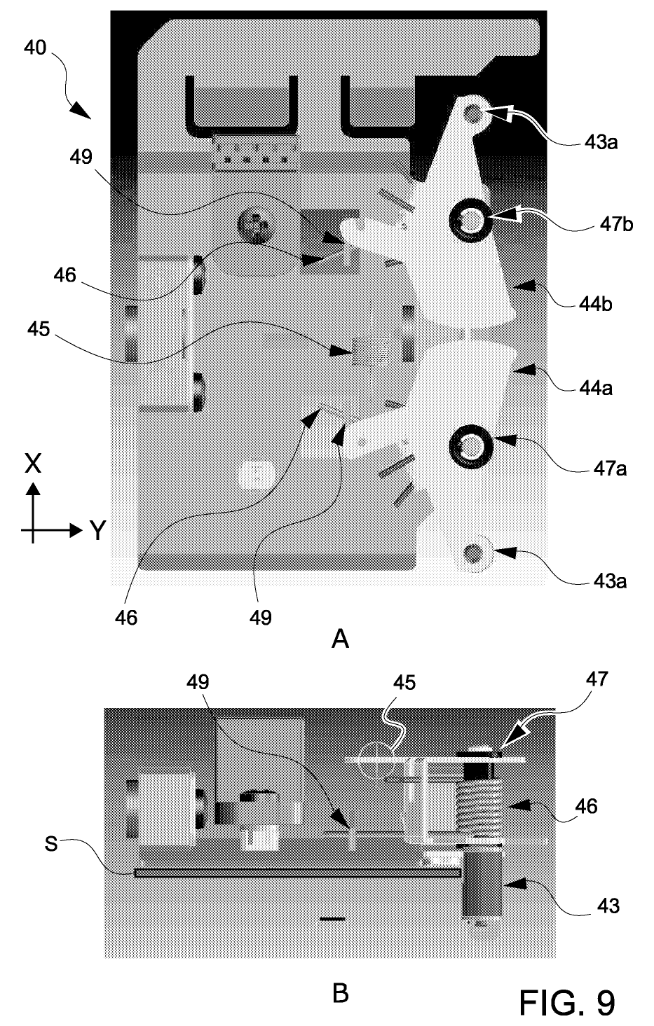

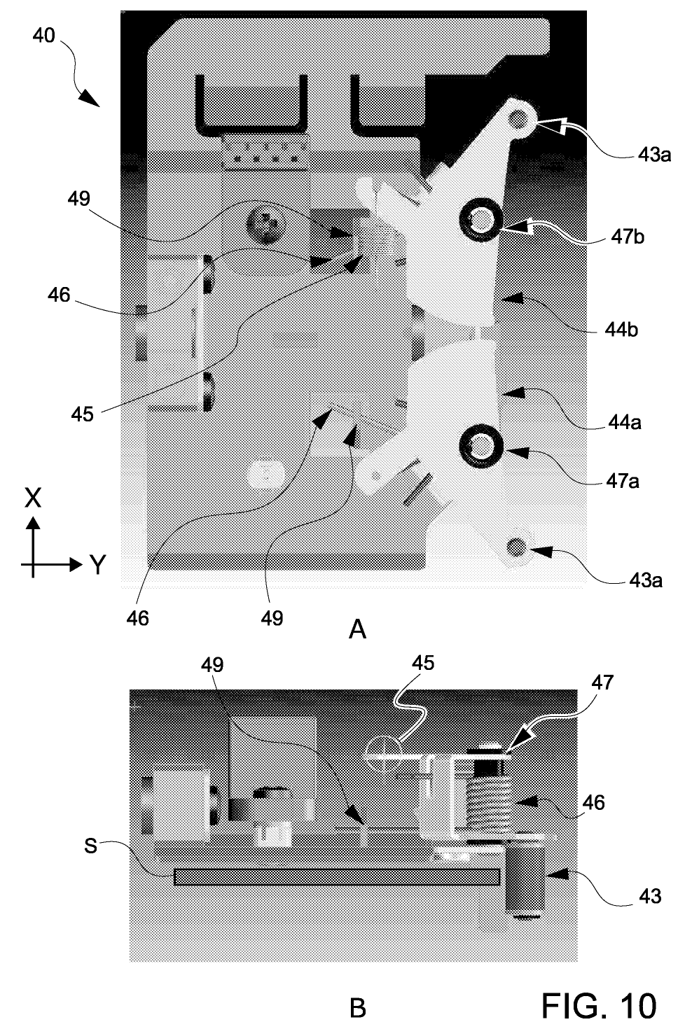

The paper width guide rollers 43a and 43b are provided at one end of each of the paper width guide levers 44a and 44b described later, and come into contact with the paper (see FIGS. 9 and 10) being transported into the paper transport area (see dotted line 50 in FIG. 7).

The paper width guide levers 44a and 44b include pivot shafts 47a and 47b which function as fulcrums for the respective paper width guide levers 44, the second width guide spring 46 which is externally fitted onto each pivot shaft 47, and a support portion 48 which supports the first width guide spring 45 that connects the paper width guide levers 44a and 44b.

The first width guide spring 45 is a tension spring supported by the support portion 48 and arranged between the two paper width guide levers 44a and 44b. The second width guide spring 46 is a torsion coil spring externally fitted to the pivot shafts 47a and 47b of the paper width guide levers 44a and 44b.

Here, an operation of the wide guide moving body will be described for a case where no paper exists and a case where the paper exists in the paper transport area.

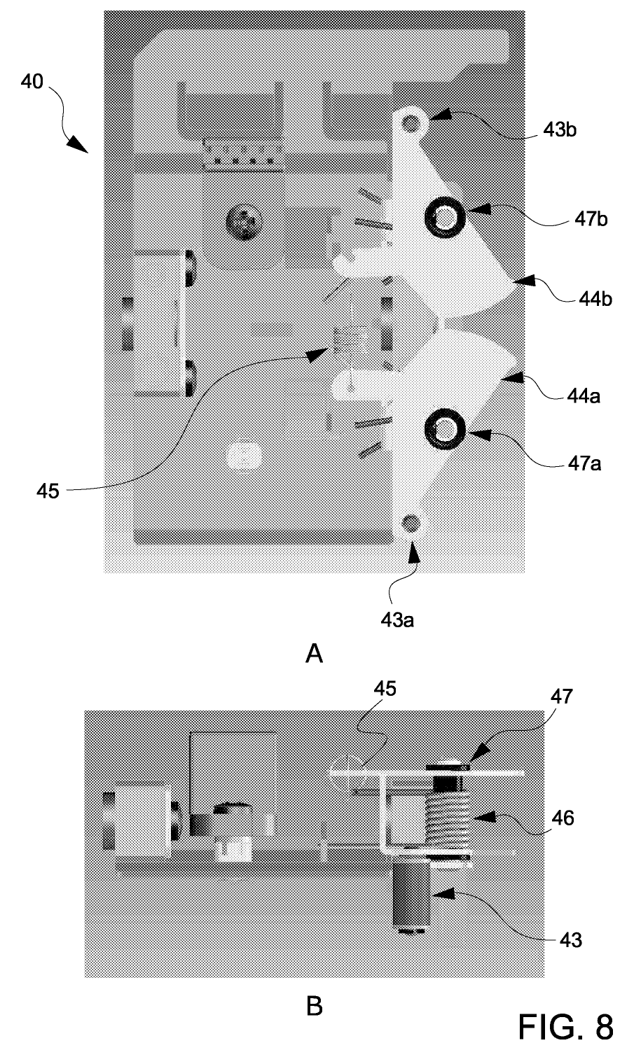

FIG. 8 is a view showing a state where no paper exists in the paper transport area (standby state). FIG. 9 shows a state where the paper is thin paper (or plain paper) and exists in the paper transport area. FIG. 10 shows a state where the paper is thick paper and exists in the paper transport area.

Definition of the thin paper or the thick paper may be determined by a paper weight, which is one of paper settings set when the user operates the image forming apparatus 1. That is, the thin paper or the thick paper may be defined based on a paper basis weight.

Subfigure A of FIG. 8 is a top view of the width guide moving body 40. Subfigure B of FIG. 8 is a view of the width guide moving body 40 as seen from the arrow direction A. As shown in FIG. 8, when no paper exists in the paper transport area, the paper does not contact the paper width guide rollers, so the first width guide spring 45 is in a natural length.

Subfigure A of FIG. 9 is a top view of the width guide moving body 40. Subfigure B of FIG. 9 is a view of the width guide body 40 as seen from the arrow direction A. As shown in FIG. 9, when the paper S (thin paper or plain paper) exists in the paper transport area, the paper width guide rollers 43a and 43b are pressed by the paper S in contact therewith, causing the paper width guide rollers 43a and 43b to move in a Y direction. Hereinafter, an amount by which the paper width guide rollers 43 are pressed by the paper S (an amount of movement in the Y direction) is referred to as a pressed amount.

The movement of the paper width guide roller 43a causes the paper width guide lever 44a to rotate clockwise about the pivot shaft 47a. Furthermore, the rotation of the paper width guide lever 44a stretches the first width guide spring 45.

Similarly, the movement of the paper width guide roller 43b causes the paper width guide lever 44b to rotate counterclockwise about the pivot shaft 47b. Furthermore, the rotation of the paper width guide lever 44b stretches the first width guide spring 45.

At this time, forces applied to the two paper width guide rollers 43a and 43b become equal. This reduces variations in the forces due to mechanical tolerance.

Stretching of the first width guide spring 45 due to the rotation of both paper width guide levers 44 generates a restoring force (load for thin paper) equal to the stretching of the first width guide spring 45. This restoring force balances the force exerted on the paper width guide rollers 43 by the paper, stopping the movement of the paper width guide rollers and completing paper alignment (positioning).

Subfigure A of FIG. 10 is a top view of the paper width guide moving body 40. Subfigure B of FIG. 10 is a view of the width guide moving body 40 as seen from the arrow direction A. As shown in FIG. 10, when the thick paper exists in the paper transport area, a greater force acts on the paper width guide levers 44 compared to the thin paper or ordinary paper because the thick paper has higher rigidity than that of the thin paper or the ordinary paper. That is, the pressed amount of the paper width guide rollers 43 become greater than that of the thin paper or the ordinary paper. In this case, in addition to the restoring force provided by the first width guide spring 45 described above, a load is generated by the second width guide spring 46.

Specifically, when the paper width guide rollers 43 are pressed by the thick paper S, the paper width guide lever 44 rotates, stretching the first width guide spring 45. At this time, if the pressed amount of the paper width guide rollers 43 is 6 mm or more, the load by the second width guide spring 46 acts on the paper.

That is, when the thin paper or the ordinary paper exists in the paper transport area, it can be said to correspond to a state where the pressed amount of the paper width guide rollers 43 is in a range of 0 mm or more and less than 6 mm. Furthermore, when the thick paper exists in the paper transport area, it can be said to correspond to a state where the pressed amount of the paper width guide rollers 43 is 6 mm or more, or a state where the first width guide spring and the second width guide spring are acting on the paper.

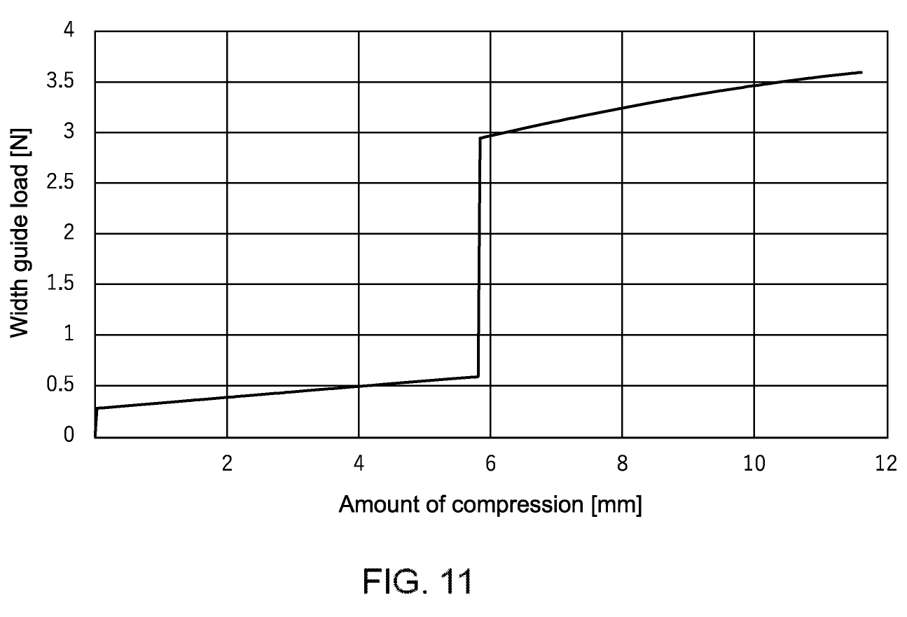

FIG. 11 is a graph indicating a load applied in a paper width guide direction (opposite to the X direction). In FIG. 11, a horizontal axis indicates the pressed amount [mm] of the paper width guide rollers 43, and a vertical axis indicates a width guide load [N].

As shown in FIG. 11, when the pressed amount of the paper width guide rollers 43 is up to 5.8 mm, the width guide load is low, meaning only the first width guide spring 45 is acting. Furthermore, when the pressed amount becomes 5.8 mm or more, both the first width guide spring 45 and the second width guide spring 46 act, resulting in a higher width guide load. Note that in FIG. 11, because the paper width guide lever 44 rotates, the width guide load in the graph shown in FIG. 11 is not linear.

In this embodiment, considering variations in a width of the paper, the range of the pressed amount at which the first width guide spring 45 acts on the paper is set to less than 6 mm. Although a certain torque is generated when the second width guide spring 46 is attached, it acts on the paper only when the paper width guide rollers 43 are pressed 6 mm or more.

Gripping the thin paper too tightly may cause a defect like buckling (bending) or wrinkling. Therefore, the thin paper requires to be gripped with a weaker force. Consequently, in this embodiment, the paper alignment apparatus is configured so that only the first width guide spring act on the thin paper.

Furthermore, in this embodiment, since the paper alignment cannot be achieved with a weak force for the thick paper, a moment acts to align the thick paper when an end of the second width guide spring 46 contacts the stopper 49 before the first width guide spring 45 for the thin paper is fully extended. Additionally, by placing the second width guide spring 46 at the stopper 49, it becomes possible to maintain an alignment force within a certain range even for the thick paper. For example, the alignment force within the certain range is approximately 3 N to 4 N, as shown in FIG. 11.

As described above, the paper alignment apparatus 100 according to this embodiment includes the alignment plate arranged parallel to a feed direction of the paper S and the width guide moving body 40 that pushes the paper S against the alignment plate, the paper S includes the thin paper or the thick paper, and the width guide moving body 40 includes the first width guide spring 45 for applying the load to the thin paper or the thick paper and the second width guide spring 46 for applying the load to the thick paper. The first width guide spring 45 applies the load to the paper S when the paper width guide rollers 43 are pressed by the paper S. The second width guide spring 46 applies the load to the paper S when the amount of movement of the paper width guide rollers 43 pressed by the paper S is 6 mm or more. This enables both thin and thick paper alignment with a simple structure.

In the related art, in order to prevent paper buckling, a paper skew correction using skew rollers requires a large and complex apparatus having a structure, for example, that varies a nip pressure.

In the present technology, during the paper transport in the image forming apparatus, in order to adjust the paper skew and the optical axis misalignment by pushing the sides of the paper against the alignment plate parallel to the paper feed direction, the load for aligning the paper is adjusted by varying an amount of operation with paper stiffness when gripping the paper from the both sides. This allows the apparatus to also function as a guide during paper feeding after the alignment, enabling improved skew correction accuracy.

Those skilled in the art will understand that various modifications, combinations, subcombinations, and alterations may be made within the scope of the appended claims or their equivalents, depending on design requirements and other factors.

It should be understood by those skilled in the art that various modifications, combinations, sub-combinations and alterations may occur depending on design requirements and other factors insofar as they are within the scope of the appended claims or the equivalents thereof.

What is claimed is:

1. A paper alignment apparatus for adjusting a paper skew, comprising:
an alignment plate arranged parallel to a paper feed direction; and
a width guide mechanism for pushing paper against the alignment plate,
wherein the paper includes thin paper or thick paper,
wherein the width guide mechanism includes paper rollers in contact with the paper, a first width guide spring for applying a load to the thin paper or the thick paper, and a second width guide spring for applying a load to the thick paper,
wherein the first width guide spring applies a load to the paper when the paper rollers are pressed by the paper, and
wherein the second width guide spring applies a load to the paper when an amount of movement of the paper rollers pressed by the paper is greater than or equal to a first threshold.

2. The paper alignment apparatus according to claim 1, wherein
the width guide mechanism includes two paper width guide levers, and wherein the first width guide spring is configured as a tension spring arranged between the two paper width guide levers.

3. The paper alignment apparatus according to claim 2, wherein
the respective paper width guide levers have pivot shafts functioning as fulcrums, and wherein the second width guide spring is configured of a torsion coil spring externally fitted to each of the pivot shafts.

4. The paper alignment apparatus as described in claim 3, wherein
the width guide mechanism has a stopper for applying an alignment force to the paper by contacting the second width guide spring.

5. The paper alignment apparatus according to claim 1, wherein
the first threshold is set on a basis of a variation in a width of the paper.

6. The paper alignment apparatus according to claim 5, wherein the first threshold is 6 mm.
